(19) United States
(12) Patent Application Publication
(10) Pub. No.: US 2024/0286933 A1
(43) Pub. Date: Aug. 29, 2024

(54) SYSTEMS AND METHODS FOR TREATING WATER IN SWIMMING POOLS AND SPAS

(71) Applicant: ZODIAC POOL SYSTEMS LLC, Carlsbad, CA (US)

(72) Inventors: Timothy McNeil, Newnan, GA (US); Zachary T. Vogtner, Fayetteville, GA (US); Anthony Levacque, Newnan, GA (US); Steven Andrews, Simpsonville, SC (US)

(73) Assignee: ZODIAC POOL SYSTEMS LLC, Carlsbad, CA (US)

(21) Appl. No.: 18/587,405

(22) Filed: Feb. 26, 2024

Related U.S. Application Data
(60) Provisional application No. 63/448,824, filed on Feb. 28, 2023.
(60) Provisional application No. 63/526,124, filed on Jul. 11, 2023.

(51) Int. Cl. C02F 1/32; C02F 1/78; C02F 103/42

(52) U.S. Cl. CPC C02F 1/325; C02F 1/78; C02F 2103/42; C02F 2201/782; C02F 2303/04

(57) ABSTRACT

An advanced oxidation process system and associated method includes a device with a housing having a wall with a first side exposed to water of the swimming pool or spa and a second side opposite from the first side. The device additionally includes an ultraviolet lamp within the housing. In some embodiments, an electrical ballast for an ultraviolet generator may be attached to the second side of the wall and in thermal contact with the wall. In certain embodiments, an end cap may be attachable to and removable from the housing, and the ultraviolet lamp may be supported by the end cap and positionable within the water chamber.

### REFERENCE TO RELATED APPLICATIONS

This application claims the benefit of U.S. Provisional Patent Application No. 63/448,824, filed on Feb. 28, 2023, entitled SYSTEMS AND METHODS FOR TREATING WATER IN SWIMMING POOLS AND SPAS, and the benefit of U.S. Provisional Patent Application No. 63/526,124, entitled SYSTEMS AND METHODS FOR TREATING WATER IN SWIMMING POOLS AND SPAS, both of which are hereby incorporated by reference in their entireties.

### FIELD OF THE INVENTION

This invention relates to systems and methods for treating water in swimming pools, spas, and similar bodies of water.

### BACKGROUND OF THE INVENTION

The treatment of water in pools, hot tubs, spas, aquariums and the like is required to ensure that various qualities and parameters, such as chemical, physical, and biological characteristics, are within given acceptable ranges. When a given chemical, physical and biological characteristic falls outside these acceptable ranges the water quality can be considered “poor,” and the water must be treated (e.g., to prevent harmful effects to a user, equipment, etc.). The water can be treated in a number of ways, including chemical dosing, irradiation, filtration, etc. As examples, the water may be exposed to ultraviolet (UV) radiation to kill bacteria and viruses and/or ozone may be provided in the water to remove pathogens and bacteria and/or otherwise provide a disinfecting effect. When ozone and UV are combined together, the ability to treat water is increased due to an advanced oxidation process (AOP). However, traditional AOP systems have several limitations.

In one aspect, traditional AOP systems (as well as UV-only water treatment systems) require an electrical ballast for powering one or more UV lamps but have a limited ability to control or limit the temperature of the electrical ballast. Traditional electrical ballasts are designed to operate at a working temperature lower than a threshold limit, which is often set by the manufacturer, but lack features preventing it from running at higher temperatures, including at or above the threshold. Excessive temperature above such a defined maximum temperature may not cause the ballast to fail immediately, but it can dramatically shorten ballast life. Traditional electrical ballasts have limited ability to control reaching the maximum temperature.

In another aspect, while some water treatment systems may be UV-only systems, AOP systems may include an injector for adding ozone gas into the water, but such injectors are susceptible to failure and/or back flow. For example, such injectors are commonly venturi injectors, which use pressure differential across a small orifice with an offset opening and a suction port. In such systems, ozone gas is pulled into the water via the suction port of the venturi injector, and due to the pressure change and forces present, the ozone gas dissolves into the water quickly. While traditional injectors for ozone systems allow for the addition of ozone gas into the water, the injectors have a fixed location and cannot be moved, thereby limiting unit installation capabilities. Moreover, traditional injectors are unable to prevent the back flow of water into the injector (and potentially to the ozone generator). As such, a problem with a water circulation system and/or if the injector is installed below a water level of the pool or spa may allow for the back flow of water into the injector towards the ozone generator, potentially damaging the ozone generator or rendering it inoperable.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, an AOP device for treating water of a swimming pool or spa includes a water chamber with a chamber wall, a UV lamp within the water chamber, and a UV generator comprising an electrical ballast attached to the chamber wall and in thermal contact with the chamber wall.

According to some embodiments, an AOP device for treating water of a swimming pool or spa includes a housing with a wall having a first side exposed to water of the swimming pool or spa and a second side opposite from the first side, a UV lamp within the housing, and an electrical ballast for a UV generator attached to the second side of the wall and in thermal contact with the wall.

According to various embodiments, an AOP device for treating water of a swimming pool or spa includes a housing with a wall having a first side exposed to water of the swimming pool or spa and a second side opposite from the first side, a UV lamp within the housing, and a mounting location for an electrical ballast for a UV generator defined on the second side of the wall and such that the electrical ballast is in thermal contact with the wall when mounted at the mounting location.

According to certain embodiments, an AOP device for treating water of a swimming pool or spa includes a housing with a water chamber for receiving water of the swimming pool or spa and an inlet to the water chamber, a UV lamp within the water chamber, and an ozone injector for injecting ozone into water entering the housing. In some embodiments, the ozone injector includes an integrated check valve. In various embodiments, the ozone injector is removable from the inlet.

According to some embodiments, an AOP system for treating water of a swimming pool or spa includes an AOP housing with an inlet, a water chamber configured to receive water of the swimming pool or spa, and an outlet. The AOP system additionally includes an ozone injector with a body having a first end defining a water inlet, a second end defining a water outlet, and an injector throat between the water inlet and the water outlet. In certain embodiments, the second end includes a coupling feature for coupling the body to the inlet of the AOP housing of the AOP system or conduit of the AOP system. The ozone injector includes an injector cap in fluid communication with the injector throat and coupled to the body. In various embodiments, the ozone injector includes a check valve retained between the injector cap and the body.

According to certain embodiments, an AOP device for treating water of a swimming pool or spa includes a housing defining a water chamber for recieving water of the swimming pool or spa, an end cap removably connected to the housing, and a UV lamp supported by the end cap and positionable within the water chamber.

According to various embodiments, an AOP device for treating water of a swimming pool or spa includes a housing defining a water chamber for receiving water of the swimming pool or spa, a UV lamp supported by the end cap and positionable within the water chamber, and a UV indicator providing a status indication of the UV lamp.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figure, in which use of like reference numerals is intended to illustrate like or analogous components.

FIG. 1 illustrates an AOP system according to embodiments.

FIG. 2 is a partially exploded view of the AOP system of FIG. 1.

FIG. 3 illustrates an AOP device of the AOP system of FIG. 1 according to embodiments.

FIG. 4 is an exploded view of the AOP device of FIG. 3.

FIG. 5 illustrates a portion of the AOP device of FIG. 3.

FIG. 6 is a partially exploded view of the AOP device of FIG. 3.

FIG. 7 is a sectional view of the AOP device of FIG. 3.

FIG. 8 is an enlarged sectional view of a portion of the AOP device of FIG. 3.

FIG. 9 illustrates an ozone injector of the AOP system of FIG. 1 according to embodiments.

FIG. 10 is an exploded view of the ozone injector of FIG. 9.

FIG. 11 is a sectional view of the ozone injector of FIG. 9.

FIG. 12 illustrates a cap of the ozone injector of FIG. 9 according to embodiments.

FIG. 13 illustrates a check valve of the ozone injector of FIG. 9 according to embodiments.

FIG. 14 illustrates a body of the ozone injector of FIG. 9 according to embodiments.

FIG. 15 illustrates a body of the ozone injector of FIG. 9 according to embodiments.

### DESCRIPTION OF THE INVENTION

Described herein are improved AOP systems for treating water of swimming pools or spas. In certain embodiments, the AOP systems described herein may provide improved thermal performance of electrical ballasts for UV generators of the AOP system. The improved thermal performance may provide improved safety, improved performance, and extend the working lifetime of the electrical ballast. Additionally, or alternatively, to the improved thermal performance, the AOP systems described herein may provide an improved ozone injector. The improved ozone injector may include an integrated check valve and minimize and/or prevent back flow of water into ozone tubing and into an ozone generator. The improved ozone injector may also be modular such that the ozone injector may be attached to a housing of the AOP system and/or remote from the housing of the AOP system to provide a desired suction force and/or installation configuration. As non-limiting examples, the ozone injector may be at various locations on or remote from the housing to improve suction, and/or the ozone injector may allow for the housing of the AOP system to be low/below a water level of the swimming pool or spa where space is available while the ozone injector is remote from the housing and high/above the water level to improve performance and mitigate risk of water backing up. Compared to traditional systems, the AOP systems described herein may be mounted in various orientations, such as but not limited to a horizontal orientation, a vertical orientation, an upside-down orientation, an orientation angled relative to horizontal or vertical, and/or any other orientation as desired, thereby providing improved flexibility of installation. In certain embodiments, the AOP systems described herein may be universal voltage (or dual voltage) devices. In various embodiments, the AOP systems described herein may have at least an IPX-5 water-resistant rating. Various other benefits and advantages may be realized with the systems, devices, and methods provided herein, and the aforementioned advantages should not be considered limiting.

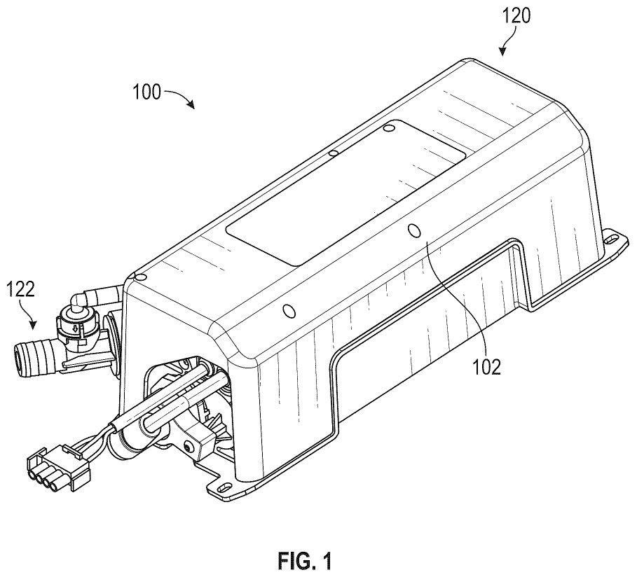

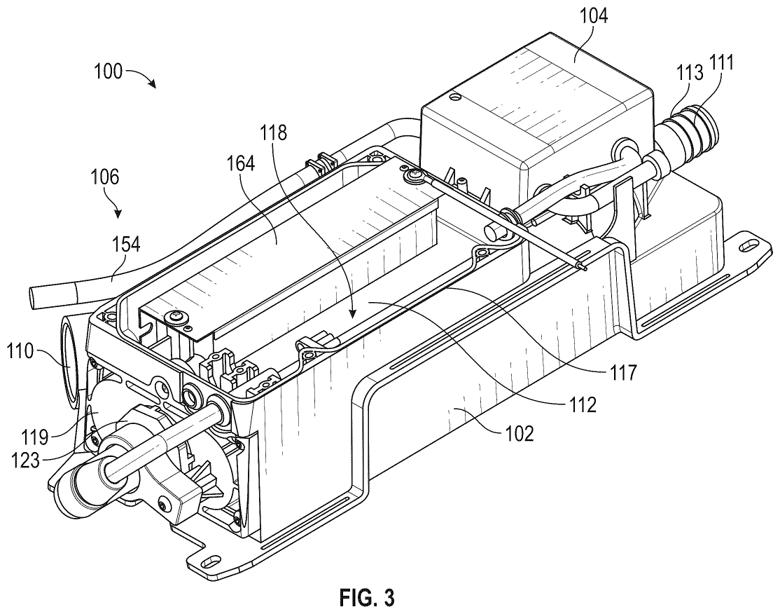

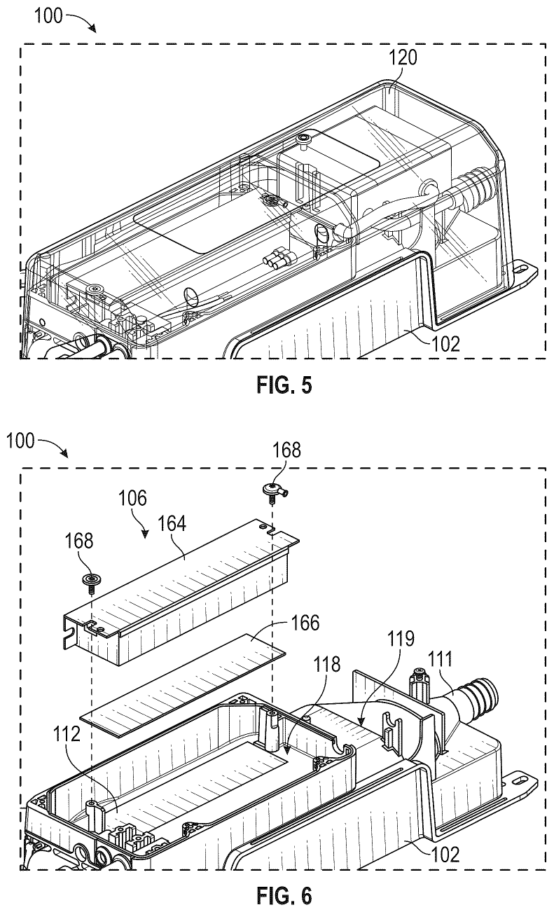

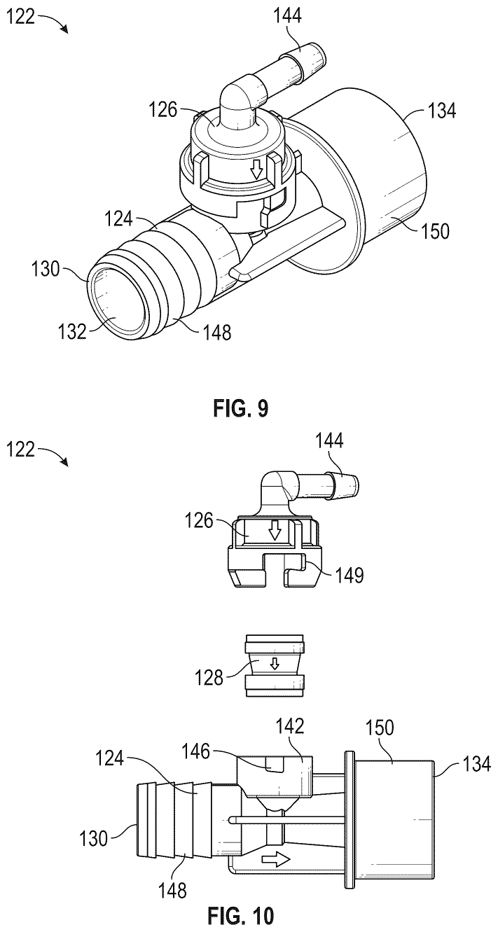

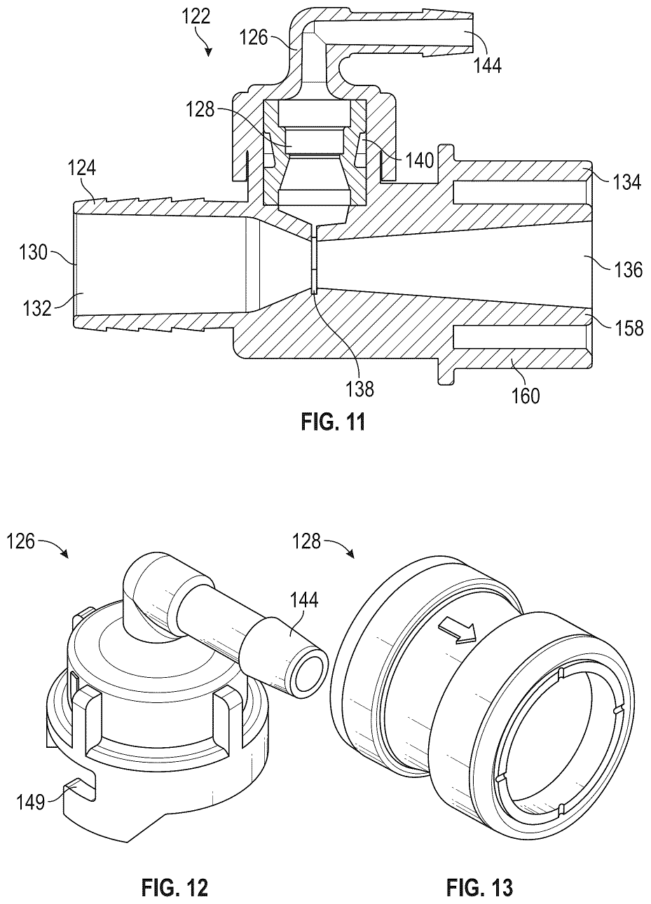

FIGS. 1-15 illustrate an example of an AOP device 100 according to embodiments. The AOP device 100 may be used to treat water of a swimming pool, spa, and/or other water-containing vessel as desired. The AOP device 100 generally includes a housing 102 and a UV generator 106 for generating UV radiation. Optionally, the AOP device 100 may include an ozone generator 104 for generating ozone.

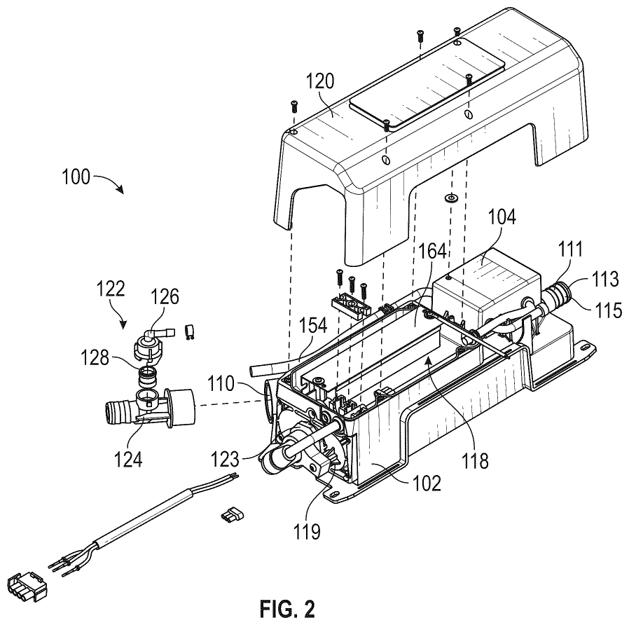

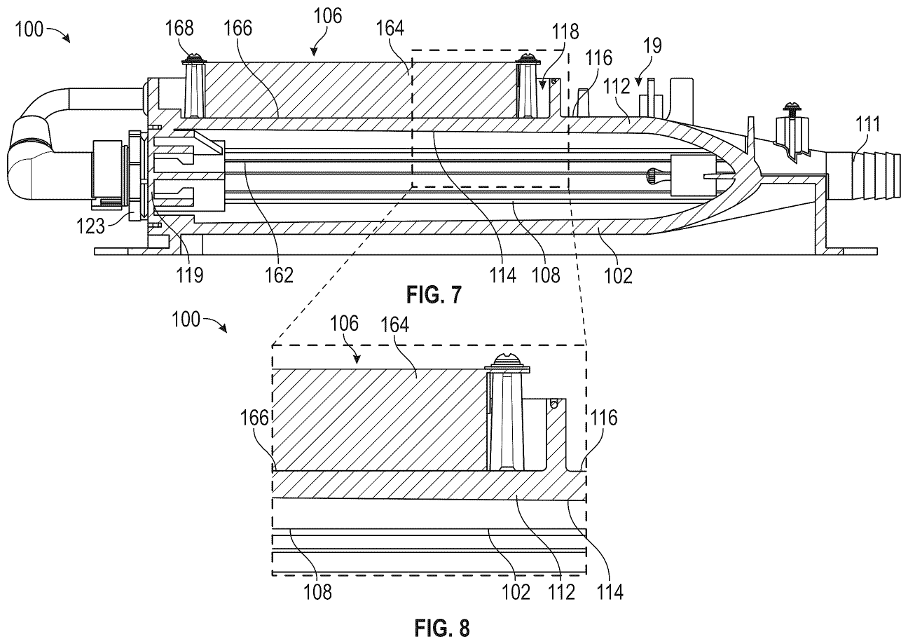

As best illustrated in FIGS. 7 and 8, the housing 102 includes a water chamber 108 having an inlet 110 and an outlet 111 such that water from the swimming pool or spa may flow into the water chamber 108 for treatment by the AOP device 100. Optionally, the housing 102 may include a plurality of inlets 110 at various locations on the housing 102 such that a configuration and/or orientation at which the water enters the AOP device 100 can be adjusted, for example to improve or modify suction. The outlet 111 may have a coupling feature 113, which may be various suitable devices or structures for engaging conduit. As non-limiting examples, in FIG. 2, the coupling feature 113 includes one or more ribs 115, although in other embodiments the coupling feature 113 need not include ribs 115 (e.g., it may be smooth).

In certain embodiments, and as best illustrated in FIG. 2, the inlet 110 optionally may extend at an angle relative to the outlet 111. In such embodiments, the inlet 110 may have an inlet axis and the outlet 111 may have an outlet axis that is not parallel with the inlet axis. In such embodiments, the inlet 110 extending at an angle relative to the outlet 111 may allow for the housing 102 to have a compact profile and provide space savings when the AOP device 100 is installed in a swimming pool or spa environment.

The water chamber 108 includes at least one wall 112 having a first side 114 and a second side 116. UV from the UV generator 106 may be provided in the water chamber 108 to provide improved treatment of water within the water chamber 108. As discussed in detail below, optional ozone from the ozone generator 104 may be combined with UV from the UV generator 106 to provide further improved treatment of water within the water chamber 108. In certain embodiments, the water chamber 108 has an improved shape and size compared to traditional approaches, thereby allowing for improved sanitation at least due to UV treatment.

In various embodiments, the first side 114 of the at least one wall 112 at least partially forms an inner surface of the water chamber 108 and is exposed to water flowing through the AOP device 100. In some embodiments, and as discussed in detail below, an electrical ballast 164 of the UV generator 106 may be attached and/or otherwise supported on the second side 116 of the at least one wall 112 such that the electrical ballast 164 is in thermal contact with the at least one wall 112. Optionally, the at least one wall 112 defines a mounting cavity 118 for receiving at least one electrical ballast 164 of the UV generator 106, and the second side 116 may form a portion of the mounting cavity 118. Optionally, the at least one wall 112 and/or another portion of the housing 102 may define a mounting location 110 for the ozone generator 104.

Optionally, a cover 120 may be attached to the housing 102. When included, the cover 120 may cover and/or enclose portions of the ozone generator 104 and/or portions of the UV generator 106 on the housing 102.

In certain embodiments, the housing 102 includes an end cap 119, and the end cap 119 may be selectively attached to or removed from the housing 102. In various embodiments, removal of the end cap 119 from the housing 102 may facilitate access to the water chamber 108 for maintenance of the water chamber 108 and/or any components within the water chamber 108 and/or as otherwise desired. The end cap 119 may be attached to the housing 102 using various mechanisms or components as desired, such as but not limited to snap-fit connections, clips, clasps, hooks, bolts, screws, pins, other mechanical fasteners, combinations thereof, and/or other mechanisms or components as desired. A sealing member 121, such as but not limited to a gasket, O-ring, and/or other suitable sealing device, is provided to form a seal between the end cap 119 and the housing 102 when the end cap 119 is attached to the housing 102, thereby sealing the water chamber 108.

The housing 102, the cover 120, and the end cap 119 may be constructed from various materials as desired. In certain embodiments, the housing 102, the cover 120, and/or the end cap 119 may be constructed from electrical insulating materials, such as but not limited to various plastics, glass, rubber, ceramics, combinations thereof, and/or other materials as desired.

The UV generator 106 of the AOP device 100 includes one or more UV lamps 162 that are powered by an electrical ballast 164. The one or more UV lamps 162 may be at least partially positioned within the water chamber 108 for treatment of water within the water chamber 108.

In certain embodiments, at least one of the one or more UV lamps 162 may be supported by the end cap 119. In such embodiments, the removable end cap 119 may facilitate removal of the one or more UV lamps 162 from the water chamber 108 for maintenance, repair, and/or as otherwise desired.

In some embodiments, a support 123 may support and/or secure the one or more UV lamps 162 on the end cap 119. The support 123 may be various suitable devices or components as desired suitable for supporting the one or more UV lamps 162, and in the example illustrated the support 123 is a nut configured to threadably engage (or otherwise attach to) the end cap 119.

In certain embodiments, the support 123 may be an indicator indicating a status of the one or more UV lamps 162 (e.g., indicating whether the one or more UV lamps 162 are on or off). In such embodiments, the support 123 may be at least partially constructed from a transparent, semi-transparent, and/or translucent material, and UV light emitted by the UV lamps 162 within the water chamber 108 may cause the support 123 to “glow” and/or may otherwise be observed on the support 123. Advantageously, the support 123 as a status indicator for the one or more UV lamps 162 may not require separate electronics to provide the indication of the status of the UV lamps 162. In other embodiments, the support 123 may be other types of indicators for indicating a status of the one or more UV lamps 162.

In certain embodiments, the support 123 as an indicator may facilitate troubleshooting and/or maintenance of the AOP system 100. As a non-limiting example, an operator may determine a problem with the one or more UV lamps 162 based on a power indicator (e.g., an LED or other indicator) on the AOP system 100 indicating that power is supplied to the AOP system 100 while the support 123 is not glowing or otherwise emitting light (e.g., indicating that the UV lamps 162 are “off”).

The electrical ballast 164 converts an input voltage (e.g., from a power source) to a value required to spark the UV lamp 162, and once the UV lamp 162 is sparked and arc is achieved, the electrical ballast 164 limits the voltage to a lower working voltage to keep the UV lamp 162 illuminated while regulating the power draw of the UV lamp 162. The electrical ballast 164 may include one or more temperature critical points, which may be portions of the electrical ballast 164 that are the hottest during use.

As best illustrated in FIGS. 2-8, the electrical ballast 164 is attached to the at least one wall 112 such that the electrical ballast 164 is in thermal contact with the at least one wall 112. The electrical ballast 164 may be attached to the at least one wall 112 using various mechanisms or devices as desired. In the embodiment illustrated, mechanical fasteners 168 such as screws attach the electrical ballast 164 to the housing 102.

In certain embodiments, the electrical ballast 164 is positioned such that at least the temperature critical point(s) are positioned proximate to the at least one wall 112. Thermal contact between the at least one wall 112 and the electrical ballast 164 may provide improved thermal performance of the electrical ballast 164 by allowing heat transfer to the water flowing through the water chamber 108 and cooling of the electrical ballast 164. Compared to traditional approaches, such positioning may limit the temperature rise in the electrical ballast 164 by cooling with the placement against the wall 112 (e.g., the water flow will facilitate cooling of the electrical ballast 164). In some embodiments, the thermal contact is due to physical contact between the electrical ballast 164 and the at least one wall 112.

In other embodiments, a thermal component 166 optionally is provided between the electrical ballast 164 and the second side 116 of the at least one wall 112 to provide improved thermal contact between the electrical ballast 164 and the at least one wall 112. The thermal component 166 may be various features, devices, and/or mechanisms for providing improved thermal contact and thermal conductivity, such as but not limited to a thermal pad, an epoxy material, other materials in other configurations, combinations thereof, and/or other components as desired. The thermal component 166 may be constructed from various conductive materials suitable for improving thermal contact and providing improved heat transfer between the electrical ballast 164 and the at least one wall 112. In other embodiments, the thermal component 166 may be omitted.

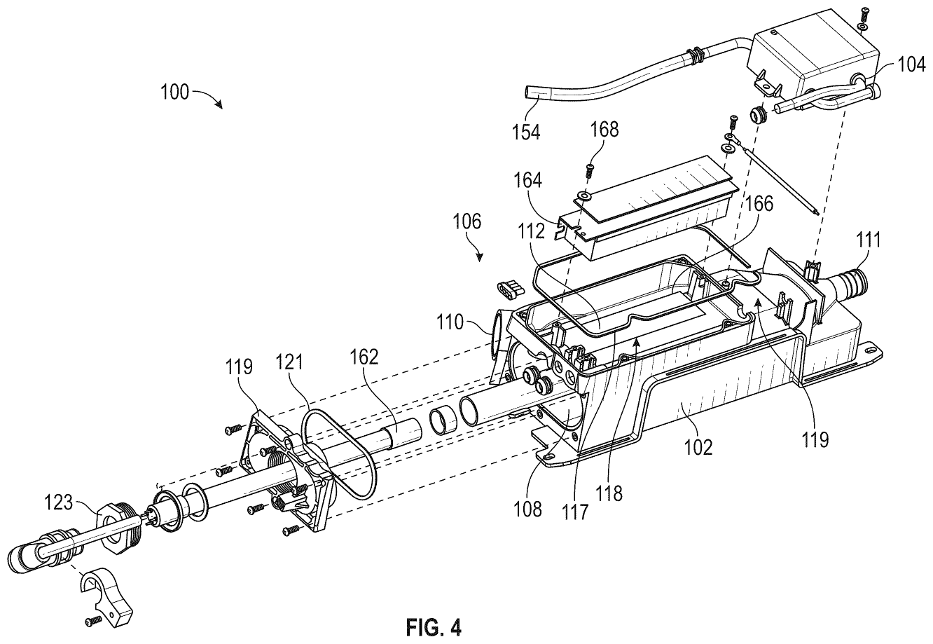

As mentioned, a mounting cavity 118 is optionally provided on the second side of the at least one wall 112, and in such embodiments, the electrical ballast 164 and/or the thermal component 166 may be provided within the mounting cavity 118. The cover 120 may cover and/or enclose portions of the ozone generator 104 and/or portions of the UV generator 106 on the housing 102 such as the electrical ballast 164 and/or the thermal component 166. In certain embodiments, and as best illustrated in FIG. 4, a sealing member 117, such as but not limited to a gasket, O-ring, and/or other suitable sealing device, is provided to form a seal between the cover 120 and the housing 102. In such embodiments, engagement between the sealing member 117 and the cover 120 may seal the mounting cavity 118 and any components provided therein.

As mentioned, thermal contact between the electrical ballast 164 and the at least one wall 112 of the housing 102 exposed to flowing water of the swimming pool or spa may provide improved thermal performance of the electrical ballast 164, thereby providing improved safety for a pool owner or user and protection to the electrical ballast 164 and other components of the AOP device 100.

As mentioned, in some embodiments, the AOP device 100 may be a UV-only device that utilizes the one or more UV lamps 162 to treat water without requiring ozone. In other embodiments, the AOP device 100 includes both the UV generator 106 for generating UV radiation and the ozone generator 104 for generating ozone.

When included, the ozone generator 104 may be various suitable devices for generating ozone, which is injected into the water of the swimming pool or spa via an ozone injector 122. Referring to FIGS. 2 and 9-15, the ozone injector 122 generally includes a body 124, an injector cap 126, and an integrated check valve 128. In certain embodiments, the ozone injector 122 is a venturi injector, and the body 124 includes a first end 130 defining an inlet 132, a second end 134 defining an outlet 136, and an injector throat 138 between the inlet 132 and the outlet 136. The body 124 also includes an injector cavity 140 in fluid communication with the injector throat 138 and having a cavity wall 142.

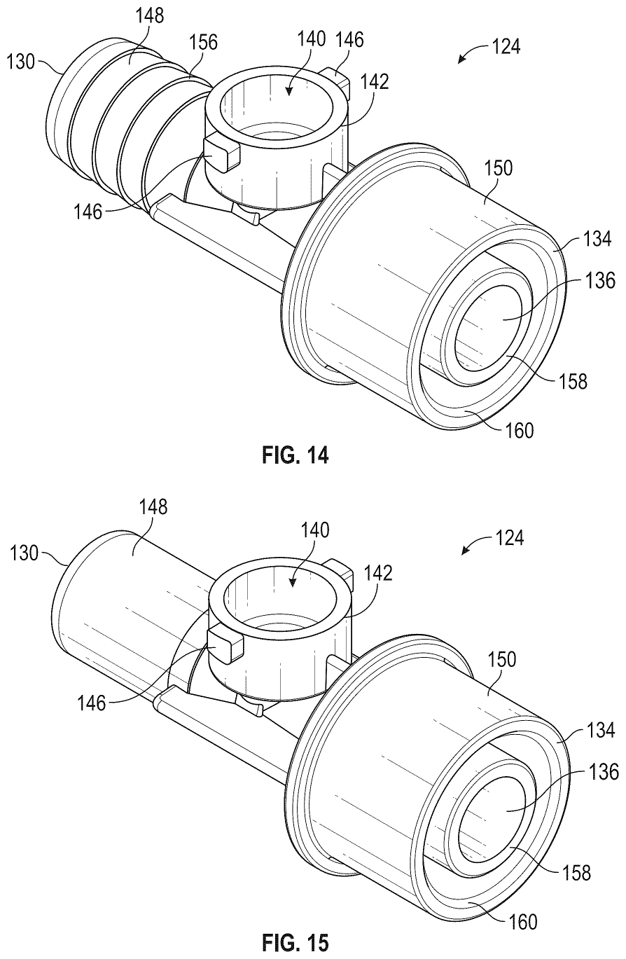

The first end 130 of the body 124 includes a first coupling feature 148 and the second end 134 includes a second coupling feature 150. The first coupling feature 148 may be various suitable devices or structures for engaging conduit 154 of the ozone generator 104. As non-limiting examples, FIG. 14 illustrates the first coupling feature 148 with one or more ribs 156, and FIG. 15 illustrates the first coupling feature 148 without ribs. The second coupling feature 150 may be modular such that the second end 134 may be connected to conduit leading to the inlet 110 of the housing 102 and/or directly to the inlet 110. In the embodiment illustrated, the second coupling feature 150 includes an inner wall 158 and an outer wall 160. Optionally, the second end 134 may be connected to conduit and/or the inlet 110 via press fitting and/or friction fitting, and a portion of the conduit and/or a portion of the inlet 110 is retained between the inner wall 158 and the outer wall 160. In some embodiments, the second coupling feature 150 with the inner wall 158 and the outer wall 160 may be attached directly to the AOP device 100, to various types of pipe, hose, and/or other conduit, and/or to standard adapter fittings (e.g., elbows, tees, couplings, reducers, etc.) for additional plumbing configurations. Additionally or alternatively, the walls 158, 160 may be glued, clamped, threaded, and/or include other coupling features as desired.

In certain embodiments, the check valve 128 is retained within the injector cavity 140 between the body 124 and the injector cap 126. The check valve 128 may be various suitable check valves for one way control of fluid through the injector cavity 140 and the injector throat 138. As a non-limiting example, the check valve 128 may include a ball or other means for controlling fluid flow through the injector cavity 140. In some embodiments, the check valve 128 may be an integrated cartridge check valve. In certain embodiments, the check valve 128 as a removable cartridge check valve may facilitate installation, maintenance, and/or replacement of the check valve 128 as needed. As a non-limiting example, a customer may install the unit and realize that the unit is not receiving sufficient gas flow/suction, the cartridge check valve may be easily replaced for a different check valve that would work at lower flow (e.g., due to a lower spring force).

The injector cap 126 includes an outlet 144 that is in fluid communication with the ozone generator 104. In various embodiments, the outlet 144 extends outwards from the injector cap 126 at an angle. In one non-limiting example, and as best illustrated in FIGS. 10 and 12, the outlet 144 may extend at about a 90° angle relative to the injector cap 126. In other embodiments, the outlet 144 may be at other angles as desired.

In certain embodiments, the injector cap 126 is attached to the body 124 such that the outlet 144 extends parallel to the body 124 and parallel to the flow of water through the inlet 132 and/or the outlet 136. Such a configuration may provide a compact injector 122 while further providing protection against water back flow. As a non-limiting example, the outlet 144 having a 90° orientation relative to the injector cap 126 allows the outlet 144 to extend parallel to the body 124, which may minimize space occupied in an outwards direction and provide improved direction of conduit attached to the outlet 144.

The injector cap 126 may be coupled to the body 124 using various mechanisms as desired. In some embodiments, the cavity wall 142 includes a tab 146, and the injector cap 126 includes a notch 149. In such embodiments, the injector cap 126 may be coupled to the body 124 by both vertically and rotationally moving the injector cap 126 relative to the body 124 such that the notch 149 engages the tab 146.

As mentioned, the ozone injector 122 with the integrated check valve 128 may minimize and/or prevent back flow of water to the ozone generator 104. The modular second end 134 of the ozone injector 122 may allow the ozone injector 122 to be directly connected to the inlet 110 or spaced apart from the inlet 110 as desired, thereby allowing for different installation configurations and/or positioning of the ozone injector 122 to control suction forces. As a non-limiting example, the ozone injector 122 may allow for the housing 102 to be low/below a water level of the swimming pool or spa where space is available while the ozone injector 122 is remote from the housing 102 and high/above the water level to improve performance and mitigate risk of water backing up to the ozone generator 104.

Exemplary concepts or combinations of features of the invention may include:
A. An AOP device for treating water of a swimming pool or spa, the AOP device comprising:
   i. a water chamber configured to receive water of the swimming pool or spa, the water chamber having a chamber wall;
   ii. a UV lamp within the water chamber; and
   iii. a UV generator comprising an electrical ballast attached to the chamber wall and in thermal contact with the chamber wall.
B. The AOP device of any preceding or subsequent statement or combination of statements, wherein the AOP device further comprises a mounting cavity on the chamber wall, and wherein the electrical ballast is mounted in the mounting cavity.
C. The AOP device of any preceding or subsequent statement or combination of statements, further comprising a thermal component between the electrical ballast and the chamber wall.
D. The AOP device of any of any preceding or subsequent statement or combination of statements, further comprising an ozone generator.
E. The AOP device of any of any preceding or subsequent statement or combination of statements, wherein the electrical ballast comprises temperature critical point at which the electrical ballast is hottest during use, and wherein the temperature critical point of the electrical ballast is proximate to the chamber wall.
F. The AOP device of any preceding or subsequent statement or combination of statements, further comprising a cover covering the electrical ballast attached to the chamber wall.
G. An AOP device for treating water of a swimming pool or spa, the AOP device comprising:
   i. a housing comprising a wall having a first side exposed to water of the swimming pool or spa and a second side opposite from the first side;
   ii. a UV lamp within the housing; and
   iii. an electrical ballast for a UV generator attached to the second side of the wall and in thermal contact with the wall.
H. The AOP device of any preceding or subsequent statement or combination of statements, further comprising a thermal component in contact with the second side of the wall and between the electrical ballast and the wall.
I. The AOP device of any preceding or subsequent statement or combination of statements, further comprising an ozone generator.
J. The AOP device of any preceding or subsequent statement or combination of statements, wherein the electrical ballast is attached to the second side of the wall such that a temperature critical point of the electrical ballast is proximate to the wall.
K. The AOP device of any preceding or subsequent statement or combination of statements, further comprising a cover covering the electrical ballast attached to the second side of the wall.
L. The AOP device of any preceding or subsequent statement or combination of statements, wherein the electrical ballast is attached to the second side of the wall using mechanical fasteners.
M. An AOP device for treating water of a swimming pool or spa, the AOP device comprising:
   i. a housing comprising a wall having a first side exposed to water of the swimming pool or spa and a second side opposite from the first side;
   ii. a UV lamp within the housing; and
   iii. a mounting location for an electrical ballast for a UV generator defined on the second side of the wall and such that the electrical ballast is in thermal contact with the wall when mounted at the mounting location.
N. The AOP device of any preceding or subsequent statement or combination of statements, further comprising a thermal component within the mounting cavity and in contact with the wall.
O. The AOP device of any preceding or subsequent statement or combination of statements, further comprising an ozone generator.
P. The AOP device of any preceding or subsequent statement or combination of statements, wherein the mounting cavity is configured to receive the electrical ballast such that a temperature critical point of the electrical ballast is proximate to the chamber wall.
Q. The AOP device of any preceding or subsequent statement or combination of statements, further comprising a cover covering the mounting cavity.
R. An AOP device for treating water of a swimming pool or spa, the AOP device comprising:
   i. a housing comprising a water chamber for receiving water of the swimming pool or spa and an inlet to the water chamber;
   ii. a UV lamp within the water chamber; and
   iii. an ozone injector for injecting ozone into water entering the housing, the ozone injector comprising an integrated check valve, wherein the ozone injector is removable from the inlet.
S. The AOP device of any preceding or subsequent statement or combination of statements, wherein the ozone injector is attached to the inlet via press fitting or friction fitting.
T. The AOP device of any preceding or subsequent statement or combination of statements, wherein the ozone injector comprises an inner wall and an outer wall, and wherein the ozone injector is configured to retain a portion of the inlet between the inner wall and the outer wall.
U. The AOP device of any preceding or subsequent statement or combination of statements, wherein the ozone device comprises:
   i. a body comprising a water inlet, a water inlet and an injector throat between the water inlet and the water outlet;
   ii. an injector cap coupled to the body and in fluid communication with the injector throat, the injector cap in fluid communication with an ozone generator; and
   iii. the integrated check valve between the body and the injector cap.
V. The AOP device of any preceding or subsequent statement or combination of statements, wherein a portion of the injector cap extends parallel to the water outlet.
W. The AOP device of any preceding or subsequent statement or combination of statements, wherein the injector cap comprises a notch and the body comprises a tab, and wherein the tab is engaged with the notch via vertical and rotational movement of the injector cap relative to the body.
X. An AOP system for treating water of a swimming pool or spa, the AOP system comprising:
   i. an AOP housing comprising an inlet, a water chamber configured to receive water of the swimming pool or spa, and an outlet; and
   ii. an ozone injector comprising:
      i. a body comprising a first end defining a water inlet, a second end defining a water outlet, and an injector throat between the water inlet and the water outlet, wherein the second end further comprises a coupling feature for coupling the body to the inlet of the AOP housing of the AOP system or conduit of the AOP system;
      ii. an injector cap in fluid communication with the injector throat, the injector cap coupled to the body; and
      iii. a check valve retained between the injector cap and the body.
Y. The AOP system of any preceding or subsequent statement or combination of statements, wherein the coupling feature of the ozone injector is a press fit or friction fit coupling feature.
Z. The AOP system of any preceding or subsequent statement or combination of statements, wherein the ozone injector is attachable to and removable from the inlet of the AOP housing.
AA. An AOP device for treating water of a swimming pool or spa, the AOP device comprising:
   i. a housing defining a water chamber configured to receive water of the swimming pool or spa;
   ii. an end cap removably connected to the housing; and
   iii. a UV lamp supported by the end cap and positionable within the water chamber.
BB. An AOP device for treating water of a swimming pool or spa, the AOP device comprising:
   i. a housing defining a water chamber configured to receive water of the swimming pool or spa;
   ii. a UV lamp supported by the end cap and positionable within the water chamber; and
   iii. a UV indicator providing a status indication of the UV lamp.
CC. The AOP device of any preceding or subsequent statement or combination of statements, wherein the UV indicator is transparent, semi-transparent, or translucent.
DD. The AOP device of any preceding or subsequent statement or combination of statements, wherein the UV indicator is a support configured to support he UV lamp on an end cap of the AOP device.
EE. The AOP device of any preceding or subsequent statement or combination of statements, wherein the AOP device comprises a universal voltage.
FF. The AOP device of any preceding or subsequent statement or combination of statements, wherein the AOP device comprises at least an IPX-5 waterproof rating.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with pools and spas, persons skilled in the relevant field will recognize that the present invention conceivably could be employed in connection with other objects and in other manners. Finally, references to “pools” and “swimming pools” herein may also refer to spas or other water containing vessels used for recreation or therapy and for which cleaning of debris is needed or desired.

That which is claimed:

1. An AOP device for treating water of a swimming pool or spa, the AOP device comprising:
i. a housing comprising a wall having a first side exposed to water of the swimming pool or spa and a second side opposite from the first side;
ii. a UV lamp within the housing; and
iii. an electrical ballast for a UV generator attached to the second side of the wall and in thermal contact with the wall.

2. The AOP device of claim 1, further comprising a thermal component in contact with the second side of the wall and between the electrical ballast and the wall.

3. The AOP device of claim 1, further comprising an ozone generator.

4. The AOP device of claim 1, wherein the electrical ballast is attached to the second side of the wall such that a temperature critical point of the electrical ballast is proximate to the wall.

5. The AOP device of claim 1, further comprising a cover covering the electrical ballast attached to the second side of the wall.

6. The AOP device of claim 1, wherein the electrical ballast is attached to the second side of the wall using mechanical fasteners.

7. The AOP device of claim 1, wherein the housing defines a water chamber configured to receive water of the swimming pool or spa, and wherein the wall is a chamber wall of the water chamber.

8. The AOP device claim 1, wherein the AOP device further comprises a mounting cavity on the wall, and wherein the electrical ballast is mounted in the mounting cavity.

9. An AOP device for treating water of a swimming pool or spa, the AOP device comprising:
i. a housing defining a water chamber configured to receive water of the swimming pool or spa;
ii. an end cap attachable to and removable from the housing; and
iii. a UV lamp supported by the end cap and positionable within the water chamber.

10. The AOP device of claim 9, wherein the end cap is configured to seal the water chamber.

11. The AOP device of claim 9, wherein the housing and end cap are constructed from an electrical insulating material.

12. The AOP device of claim 9, further comprising a support supporting the UV lamp on the end cap, and wherein the support is attachable to and removable from the end cap.

13. The AOP device of claim 9, further comprising a support supporting the UV lamp on the end cap, and wherein the support is further configured as an indicator indicating a status of the UV lamp at least while the UV lamp is within the water chamber.

14. The AOP device of claim 9, further comprising an ozone generator.

15. An AOP device for treating water of a swimming pool or spa, the AOP device comprising:
i. a housing defining a water chamber configured to receive water of the swimming pool or spa;
ii. a UV lamp supported by the end cap and positionable within the water chamber; and
iii. a UV indicator providing a status indication of the UV lamp.

16. The AOP device of claim 15, wherein the UV indicator is transparent.

17. The AOP device of claim 15, wherein the UV indicator is semi-transparent.

18. The AOP device of claim 15, wherein the UV indicator is translucent.

19. The AOP device of claim 15, wherein the UV indicator is a support configured to support he UV lamp on an end cap of the AOP device.

20. The AOP device of claim 15, wherein the AOP device comprises at least one of universal voltage or an IPX-5 waterproof rating.
